(19) United States
(12) Patent Application Publication
(10) Pub. No.: US 2018/0267939 A1
(43) Pub. Date: Sep. 20, 2018

(54) METHOD OF EDITING AN ELECTRONIC MESSAGE WITH ELIMINATION OF REDUNDANT ELEMENTS

(71) Applicants: ATOS INTEGRATION, Bezons (FR); GREENADDIN, Paris (FR)

(72) Inventors: Serge TACHNOFF, Paris (FR); Hugo NGUYEN, Paris (FR)

(21) Appl. No.: 15/847,769

(22) Filed: Dec. 19, 2017

(30) Foreign Application Priority Data
Dec. 19, 2016 (FR) 1662735

(51) Int. Cl. G06F 17/21; G06F 17/24; H04L 12/58; G06F 3/12

(52) U.S. Cl. CPC G06F 17/212; G06F 17/24; H04L 51/063; G06F 17/2235; G06F 3/1224; H04L 51/22; G06F 3/1219

(57) ABSTRACT

Method for editing, from an electronic messaging system, a simplified document based on an email comprising a succession of recalled unitary messages, this method comprising the operations consisting of:
editing the email;
identifying in the email the recalled unitary messages;
analysing each recalled unitary message thus identified;
detecting elements having several occurrences in several recalled unitary messages;
editing the simplified document while conserving at most a single occurrence of any element detected as having several occurrences.

The invention relates to the domain of electronic messaging systems, and more precisely to the edition and/or printing of documents from electronic messages.

In the operations that consist of replying to or forwarding an email, the textual content of this old email is generally repeated in the new email, in order to allow the recipient to be aware of the old email.

When reply or forward operations follow each other, which is frequent over the life cycle of an email (which can extend from a day to several weeks, even several months), old messages (called recalled messages) accumulate in the new email.

Now, many users wish to make digital editions of their emails, including the most recent, (for example, as documents in the format defined by ISO Standard 32000-1: 2008, currently called PDF (Portable Document Format)) or printouts.

The edition of a document in PDF format is the electronic equivalent of a physical printout of the same document, to the extent that the document produced preserves the form of the initial document, and in particular its pagination, its fonts, any images or other graphic objects (e.g. the separation lines, which are much used by messaging systems to separate message bodies), or hyperlinks, unless the message is configured in plain text

Such that, when the email is edited (or printed), the document produced repeats the totality of the content of the email. When the email includes a chain of preceding exchanges (whether it is an email of the “reply” or “forward” type), the document produced is unnecessarily long. When the document is electronic, this results in an unnecessary and unjustified consumption of memory space, and more generally, of energy. When the document is physical, the result is an unjustified consumption of ink, paper and electricity.

The user therefore frequently wishes to delete, in the document to be edited (or printed), passages they do not wish to be shown. The format used to represent emails (generally MSG—more rarely EML—in the case of Microsoft® Outlook® and Exchange® messaging systems) makes direct alteration of the message by the user impossible.

In effect, it is necessary to follow a sequence of operations, which, most often and in most versions of the Microsoft® Outlook® mailbox, comprises opening the message, selecting the action “change the message”, selecting the passages to be deleted, then deleting them. The edited or printed document then conforms to the user's wish. However, this method is tedious; furthermore, it has the disadvantage of corrupting the message if the user inadvertently saves changes they have made for the purpose of editing or printing. This can result in an irreversible loss of data.

In European Patent EP 1 327 192 (Kent Ridge Digital Labs), it has been proposed, in the emails of a mailbox, to detect redundant content and to delete the redundancies directly in the email files. This solution, which could be suitable within the framework of a personal family or family mailbox, would not be suitable within the framework of a professional mailbox, where it is important to preserve the traceability (and hence the integrity) of the messages.

A first objective is consequently to propose a method enabling the edition and printing of documents simplified in an automatic manner from emails containing redundant content.

A second objective is to propose such a method that nevertheless enables the totality of the meaningful content present in the recalled messages of the edited email to be retained in the simplified document.

For this purpose, a method is proposed in the first instance for editing, from an electronic messaging system, a simplified document based on an email comprising a succession of recalled unitary messages, this method comprising the operations consisting of:
editing the email;
identifying in the email the recalled unitary messages;
analysing each recalled unitary message thus identified;
detecting elements having several occurrences in several recalled unitary messages;
editing the simplified document while conserving at most a single occurrence of any element detected as having several occurrences.

The document thus edited occupies a reduced memory space (with a reduced energy consumption), or, if it is a document intended to be printed, makes it possible to achieve energy savings (ink, paper, electricity).

The automation of the steps saves the user from proceeding to a manual selection of the passages to keep for the purpose of the edition or of the printout.

According to various additional characteristics, taken separately or combined:
the step of identifying the unitary messages is preceded by a step of determining the IT structure of the edited email, and the step of identifying the recalled unitary messages comprises the detection, in the IT structure of the email, of at least one of the elements among:
   a header field;
   in a message body, a signature and/or a warning note (e.g. a legal warning note, a note of an environmental nature, a warning note concerning computer viruses).
the detection of a header field, a signature or a legal warning in the first analysed recalled unitary message is followed by a step of storing, in a dictionary, the detected element, and the detection of any new element in another recalled message of the email is followed by a comparison of this element with the stored elements of the same nature;
the compared element is deleted from the simplified document if it is identical to an element already stored;
the detection of a header field comprises the detection of at least one of the following keywords, situated at the head of a line of characters: from, to, date, sent, Cc, copy, object, subject, re;
the detection of a header field comprises the detection of at least one of the abovementioned words when it is followed by the symbol “:”;
the detection of a signature comprises the detection, in the message body, of at least one of the following keywords, situated at the head of a line of characters: mail, email, electronic mail, web, site, blog, telephone, tel, fax, mobile, address, assistant (male and female), leader, department, director, manager, consultant, engineer, quay, road, avenue, cul-de-sac, lane, project, projects or their equivalents in any other language;
the detection of a signature comprises the detection of at least one of the abovementioned words when it is followed by the symbol “:”;
the detection of a signature comprises the detection of at least one affected character chain of a hyperlink;
the detection of a signature comprises the detection of at least one image;
it is planned to delete, in the simplified document, any image detected in the email;
the detection of a signature disregards the presence of any potential image;
the detection of a legal warning note comprises the detection of at least one of the following keywords: warning, disclaimer, message, internet, information, error, virus, issuer, sender, integrity, environment, responsibility, confidential, legislation, prohibited, note, legal, electronic mail, disclosure, recipient, privilege, address, communication, publication, use, document, sent, electronic, manager, attachments, warn, service, corruption, content, circulation, client, immediately, send, or their equivalents in any other language, potentially used in countries whose official language is not this one;
the step of editing the email is followed by a step of detection, in the email, of at least one separation bar;
the detected bar is replaced in the simplified document by a thinner bar;
an operation is planned for detecting any hyperlink in the email, the edited document lacking any hyperlink;
an operation is planned for detecting any highlighting in the email, the edited document lacking any highlighting;
the method comprises the deletion of all recalled unitary messages.

In the second instance, a method is proposed for printing an electronic document from an email comprising a succession of recalled unitary messages, this method comprising, in addition to the succession of steps of the editing method as described above, a step of printing the edited simplified document.

Other objects and advantages of the invention will emerge in the light of the description of an embodiment.

An email is a document generated by an electronic messaging system and exchanged, via a telecommunications network, between a sender and one or more recipients.

An email is characterized by an electronic structure, which comprises:
an envelope, whose function is to allow the conveyance of the email, and which exists as a description starting with the term “from” and containing the data necessary for transporting (and relaying) the email, including the electronic addresses (consisting of two character chains separated by the character @) of the sender and that or those of the recipient(s), and the timestamp data inserted by the servers relaying the email;
a message, consisting in turn of two elements:
   a header block comprising header fields, consisting of a succession of lines of text each containing a description of a parameter of the message, including in particular:
      a line of text identifying the issuer and comprising, at its start, the term “from”, followed by the electronic address of the sender, potentially preceded or followed by an alias;
      a line of text identifying the recipient(s) and comprising, at its start, the term “to”, followed by the address of the recipient (or of each recipient), potentially preceded or followed by an alias;
      a line of text identifying the date (and potentially the time) the email was created or sent, and containing that date (and potentially that time) in a standard date (respectively time) format;
   a message body, which exists as a block containing text and/or images and/or, if applicable, other electronic objects, such as clickable hyperlinks or geometric shapes, in particular one or more separation bars.

An email frequently includes, in its body, all or part of the contents of at least one other message, called “recalled message”, which bears a date or time prior to that of the abovementioned email and which has already been sent, received or forwarded by the sender of this email or by a third party.

It is even frequent for an email to contain several recalled messages, which thus constitute a sequence or a chain of discussion, which the email follows up (and refers to).

An example of an imaginary email is shown below (any resemblance to living persons being accidental), as it exists for a user based on an ordinary electronic mailbox, such as Microsoft® Outlook®, from the address jack@johndoeslawyer, recipient of the email (supposing that this address corresponds to the user in person):

It can be seen that this email, hereinafter called “email to be edited”, which can be read in the electronic mailbox jack@johndoeslawyer.com, comprises a succession of several unitary messages, namely, in the descending vertical direction:
in the first instance, a main message, hereinafter designated Msg#0, the latest one, sent to the address jack@johndoeslawyer.com, and whose content is as follows:
in the second instance, a succession of recalled unitary messages, hereinafter designated Msg#i, where i is a whole number and whose respective contents are as follows (here in descending vertical order, which corresponds to a reverse chronological order):

Each message has an ordinary structure, and comprises a header block followed by a message body. As an example, the recalled message Msg#5 comprises:
the following header block:
the following message body:

The message body itself comprises:
a meaningful content, which exists here as a text containing one or more sentences, e.g. in the case of the recalled message Msg#5:
a signature, which exists as a block of lines containing information relating to the identity, and, if applicable, the physical details of the message sender: for example, in the case of the recalled message Msg#5:
if applicable, a warning note (e.g. a legal note, a note of an environmental nature, or a warning note concerning computer viruses), consisting of a block of lines (or a single paragraph) containing general information that does not only concern the recipient, but can concern third party readers, and relates for example to processing the information and the respective liability of the sender, the recipient and potentially of third parties, e.g. in the case of the recalled message Msg#5!

Although the content of the email to be edited is given as an example, it makes it possible to illustrate the problem faced by the user (here, the recipient of the email to be edited), when they want to make an edition of this email, either as an electronic document (typically in PDF format) for archiving purposes, or as a printed document.

In effect, the user (here the user of the mailbox jack@johndoeslawyer.com) may wish to keep, for the requirements of their business and/or for their archive, the content of the exchanges, that is to say, the content of the main message Msg#0, as well as that of the recalled messages Msg#i, while wishing to save on repetitions of certain elements such as signatures.

Likewise, it may be advisable for separation bars, for example of the following types:

potentially associated with a name, e.g.:
to be deleted, or at the very least, made thinner to save memory (in the case of an electronic document) or ink (in the case of a printed document).

This is why a method is proposed, based on an electronic messaging system (such as Microsoft® Outlook®), for editing a simplified document based on an email (such as the above email to be edited), comprising a succession of recalled unitary messages, where the simplified document repeats a first part of the content (in particular the meaningful content of the recalled messages) of the email to be edited, while abandoning another part of the content (in particular repetitions of the signatures).

This editing method is a first editing operation of the email. This operation is conducted in a conventional manner in the electronic messaging system, e.g. by double clicking on the line of the message which appears in the history of the elements received (or sent, or in any other file in which the email may have been archived by the user or automatically by the messaging system).

Editing the email results, from the viewpoint of the user, in a window opening in which the content of the message is displayed as it is presented in the above example.

In parallel with this display, the system loads into memory the IT structure of the email, which exists as a data file whose format conforms to an object model supplied by the system. In the case of Microsoft® Outlook®, the object model is called Mailltem, and its syntax is as follows:

```
<[%$TOPIC/bb643865_en-us_office_15_1_0_0_0_0%](“00063034-
0000-0000-C000-000000000046”)> _{—}
<[%$TOPIC/bb643865_en-
us_office_15_1_0_0_0_1%](GetType([%$TOPIC/bb643865_en-
us_office_15_1_0_0_0_2%]))> _{—}
PublicInterfaceMailItem _{—}
    Inherits[%$TOPIC/bb643865_en-us_office_15_1_0_0_0_3%],
[%$TOPIC/bb643865_en-us_office_15_1_0_0_0_4%]
DiminstanceAsMailItem
[[%$TOPIC/bb643865_en-us_office_15_1_0_2_0_0%](“00063034-
0000-0000-C000-000000000046”)]
[[%$TOPIC/bb643865_en-
us_office_15_1_0_2_0_1%](typeof([%$TOPIC/bb643865_en-
us_office_15_1_0_2_0_2%]))]
publicinterfaceMailItem : [%$TOPIC/bb643865_en-
us_office_15_1_0_2_0_3%],
  [%$TOPIC/bb643865_en-us_office_15_1_0_2_0_4%]
```

The IT structure of the email contains all the information (according to the syntax specified above in the case of Microsoft® Outlook®) making it possible to edit the email in the window displayed by the system for the intention of the user.

A second step consists of identifying, in the email, the recalled unitary messages Msg#i. These recalled messages Msg#i (where i is strictly greater than 1), will in effect (except for the main message Msg#0) be subject to trimming for the purpose of editing the simplified document.

This identification takes place automatically by detection of a separation bar or a header block, which comprises one or more header field(s).

According to an embodiment, the detection of a header field comprises the detection of at least one keyword, situated at the head of a line of characters, and chosen from a predefined list of keywords. According to a particular embodiment, this list comprises for example the following words: from, to, date, sent, Cc, copy, object, subject. This list, non-exhaustive and supplied as a simple illustrative example, comprises words that are usually found, in the language of this Application, in the header fields. However, the list of keywords can comprise words chosen in any other language, or in several languages. In effect, the elements (header block, body) of a recalled message are not translated by the messaging system and are repeated as they are in the email. It may therefore be advisable to compile a list of keywords comprising words in several languages, typically English, French, Spanish, German.

An example of a multilingual list of the keywords used to detect the header blocks comprises the following words: from, de, von, to, à, a, nach, date, fecha, datum, sent, envoyé, espedido, geschickt, cc, copy, copie, copia, Kopie, object, objet, Objekt, objeto, subject, sujet, tema.

It will be noted that it is not necessarily advisable to omit the information contained in the header blocks from the simplified document.

However, it may be advantageous to present them in abbreviated form.

The following header block:

can therefore be reformatted as follows, omitting certain fields and deleting some information (e.g. an electronic address when an alias is available), by concatenating them and/or changing their structure (e.g. a long date can be reformatted in an abbreviated format such as DD/MM/YYYY or MM/DD/YYYY):

In any event, the detection of the header block of each message can be accompanied by a backup operation, in a database, of the data contained in the header fields. Thus, in the present case, the content of the header field “From”, which comprises an alias “The Thieves” and an address “info@bigthiefs.com” can be stored in the database, preferably in two distinct interlinked inputs, a first input for the alias and a second for the address.

A third step consists of analysing each recalled unitary message identified in this way. An objective of this step is to detect, in each recalled message, the message body, which may comprise redundant elements or information, which it may be advisable to omit in the simplified document.

In order to detect the body of a recalled message, it is not indispensable to have a list of predefined keywords in memory (irrespective of their language). In effect, a body of a recalled message extends between:
a high limit, which is necessarily a header block (detected by the method described above, and potentially preceded by a separation bar);
a low limit, which may be:
   the bottom of the page of the email,
   or a separation bar,
   or another header block (detected by the method described above).

This analysis step advantageously comprises the detection of at least one of the following elements:
signature;
warning note (e.g. a legal warning note, a note of an environmental nature, a warning note concerning computer viruses).

The analysis step may potentially comprise the detection, in the message body, of meaningful content, that is to say, content generated or integrated by the message sender, other than a signature and a warning note.

The detection of a signature and/or a warning note takes priority over that of meaningful content, since it is a question of elements that can be simplified without the need for a linguistic analysis.

It is possible to detect a signature or a warning note by detecting the occurrence of keywords, since the majority of signatures and warning notes are generally formatted.

A signature thus generally comprises, over a succession of lines without line spacing, information containing at least a postal address and/or a telephone number. A postal address can be detected by a postcode (Zip code) or a word designating a type of thoroughfare; a telephone number can be detected by a succession of numbers, potentially separated by spaces and often containing as a prefix, the character “+”.

In practice, the detection of a signature comprises for example the detection, in the message body, of at least one of the following keywords, situated at the head of a line of characters: mail, email, electronic mail, web, site, blog, telephone, tel, fax, mobile, address, assistant (male and female), leader, department, director, manager, consultant, engineer, quay, road, avenue, cul-de-sac, lane, or their equivalents in one or more other languages. The detection of the signature can also comprise the detection of a succession of neighbouring (or adjacent) numbers, which characterizes the formulation of a telephone number. The detection of a signature can also comprise the detection of a chain of characters associated with a hyperlink (which can characterize the formulation of a mailbox address or a link to an Internet site).

As an example, the signature present in the body of the recalled message Msg#5 can be detected by the presence, in a succession of lines without line spacing, of two keywords (“Avenue” and “Tel”) present in the above list, and of a sequence of numbers (0800 00 00), characteristic of a telephone number:

Likewise, a warning note generally comprises, over a succession of lines without line spacing (even in a single block) information that contains, typically in the case of a legal note, keywords characteristic of the legal reservations and/or recommendations made by the sender of the message or by their organisation.

In practice, the detection of a warning note comprises for example the detection, in the message body, of a least one of the following keywords: warning, disclaimer, message, Internet, information, error, virus, issuer, sender, integrity, environment, responsibility, confidential, legislation, prohibited, note, legal, electronic mail, disclosure, recipient, privilege, address, communication, publication, use, document, sent, electronic, manager, attachments, warn, service, corruption, contents, circulation, client, immediately, send, or their equivalents in one or more other languages.

Signature and warning note are often situated at the end of the message body. Consequently, in order to speed up the analysis, it is preferable to proceed to the detection of the signature and/or the legal note by starting at the bottom of the message body, then moving up it. This method makes it possible to dispense with the analysis of the meaningful content, since, in the hypothesis in which a signature and/or a legal note exist in the message body, these elements are detected before the last line of the meaningful content is explored.

The analysis step may also comprise the detection (advantageously systematic) of the presence:
of any hyperlink (consumer of memory resources);
and/or of any highlighting (consumer of energy and, in the case of a printout, of colour ink).

This analysis step is followed by a step of storing, in a dictionary database, the detected element (signature and/or warning note).

The analysis of the signature may be sufficiently refined to distinguish a name and/or a first name (associated if applicable), a postal address, a telephone number, an electronic address. This information is commonly placed on different lines. It is consequently possible to store it, in the database, in several respective different inputs: a first input for the name, a second input for the address, a third input for the telephone number, a fourth, if applicable for the electronic address.

On account of the structure of the signature, storage in the database of the signature detected in the recalled message Msg#5 may be achieved in the following manner in a “signature” input associated with this message:

It will be noted that the detection of a signature can comprise the detection of an image. This detection can be conducted in a conventional manner by detecting an electronic object integrated with the message body in a format usually corresponding to an image (such as .gif, .pdf, .bmp). This image may be stored in an input of the database, associated with the signature data.

A contrario, in order to simplify (and therefore shorten) the process, the detection of the signature may, systematically, disregard the presence of potential images.

Like the signature, the legal note is advantageously stored in a dedicated input of the database.

Thus, for the recalled message Msg#5, the storage of the legal note can be achieved in the following manner in a “legal note” input associated with this message:

These analysis steps (and more precisely the detection of a header block and the detection of a signature and/or a legal note) are repeated for all of the recalled messages Msg#i for i=1 to N, where N is the number of recalled messages.

It will be noted that the incrementation of the index i may correspond to a scan of the email from top to bottom (i=1 therefore corresponding to the first recalled message below the main message Msg#0 and i=N corresponding to the last recalled message in descending order) or, inversely, from bottom to top (i=1 thus corresponding to the last recalled message in the email, and i=N corresponding to the first recalled message below the main message Msg#0).

The analysis of each following recalled message Msg#i is advantageously followed by a operation of comparing each detected element (header block or field, signature or legal note) with the elements of the same nature (signature, or respectively, legal note) already stored for recalled messages already analysed.

This comparison aims to detect elements having several occurrences in several recalled unitary messages, in order to keep at most one occurrence in the simplified document.

In order to perform this comparison, each detected element is compared with the corresponding element of the same nature in the database.

As an example, supposing that the analysis of the recalled messages is performed in the increasing direction of the incrementation, the following signature, detected in the recalled message Msg#4:

is identical to the signature already detected in the recalled message Msg#2 (and stored in the database).

Likewise, the following warning note (here a legal note), detected in the recalled message Msg#3:

. . . is identical to the warning note already detected in the recalled message Msg#1 (and stored in the database).

The warning note example given above is a legal note; it could be an environmental note, such as:

. . . or a warning relating to virus protection:

Having thus detected the multiple occurrences, the simplified document can be edited, keeping at most one single occurrence of any element detected as having several occurrences.

According to a particular embodiment, a compared element is deleted from the simplified document if it is identical to an already saved element. As a variant, the compared element can itself be simplified. Thus, in a signature having several occurrences, it is conceivable, in the simplified document, to keep the first (or the last) occurrence of the complete signature, and for each new occurrence, only to keep the identified name, which it suffices to extract from the corresponding input of the database.

Any image detected (if applicable) in the email or, more precisely, in any one of the recalled messages, is advantageously omitted from the simplified document (that is to say deleted from it).

Likewise, the simplified document is advantageously empty of any hyperlinks. The character chains, which were associated with a hyperlink in the analysed email, can however be kept.

Like hyperlinks, highlighting detected in the email is advantageously deleted from the simplified document.

A specific step can also be planned in the email for detecting at least one separation bar between two recalled messages

The presence of separation bars in the electronic correspondence aims to make it easier to read, since they allow the limits of the recalled messages to be visually identified. However, it is not necessary, in the simplified message, to keep the initial size and font of the separation bar.

Thus, according to an advantageous embodiment, each detected separation bar is replaced, in the simplified document, by a thinner bar.

Thus, a detected bar, which is presented for example like this in the email:

. . . is replaced in the simplified document by a thinner bar, which is presented for example like this:

Thus, in fine, the simplified document (that is to say, the simplified version of the email) can be presented for example like this:

The simplified document thus edited occupies, thanks to the deletion of all or part of the multiple occurrences, a reduced memory space and consumes less energy. From the viewpoint of form, it appears substantially more compact and more legible. If the simplified document is intended for printing, this simplification makes it possible to achieve savings of energy and consumables (ink, paper, electricity).

It goes without saying that what has just been described is automated and performed by a computer programme implemented on an IT processing unit (processor) integrated in an office computer or a server (physical or virtual), a printer.

According to a particular embodiment, even all of the unitary messages can be deleted from the simplified document, keeping only the main message. This deletion is advantageously accessible in an optional manner via a dedicated control on a console for controlling the editing of the simplified message.

The implementation of the different steps may take place inside the actual electronic messaging system. For this purpose, the programme mentioned below exists advantageously as a plugin or an addin, natively supplied in the messaging system or added subsequently. As a variant, the programme exists as an application separate from the messaging system.

The different steps are controlled by appropriate instructions of a computer programme implemented on an IT control unit integrated in a computer or a server (physical or virtual).

It will be noted that it is conceivable to calculate (and potentially to display) the proportion of the content of the email deleted from the simplified document (or a contrario the proportion of content kept).

It is also conceivable, in order to make the simplified document as compact as possible, to delete any empty lines or supernumerary spaces.

However, it is preferable to keep certain data having special formatting, e.g. as a table. It may also be preferable to keep the images (other than signature images).

1. Method for editing, from an electronic messaging system, a simplified document based on an email comprising a succession of recalled unitary messages, this method comprising the operations consisting of:
editing the email;
identifying in the email the recalled unitary messages;
analysing each recalled unitary message thus identified;
detecting elements having several occurrences in several recalled unitary messages;
editing the simplified document while conserving at most a single occurrence of any element detected as having several occurrences.

2. Method according to claim 1, characterized in that the step of identifying the unitary messages is preceded by a step of determining the IT structure of the edited email, and in that the step of identifying the recalled unitary messages comprises the detection, in the IT structure of the email, of at least one header field.

3. Method according to claim 1 or claim 2, characterized in that the detection of a header field comprises the detection of at least one of the following keywords, situated at the head of a line of characters: from, to, date, sent, Cc, copy, object, subject, re.

4. Method according to one of claims 1 to 3, characterized in that the analysis of each unitary message comprises the detection, in this message, of a body of this message.

5. Method according to claim 4, characterized in that the analysis step comprises the detection of at least one of the following elements: signature, legal note.

6. Method according to claim 5, characterized in that the analysis step is followed by a step of storing, in a dictionary database, the detected element, and in that the detection of any new element in another recalled message of the email is followed by a comparison of this element with the stored elements of the same nature.

7. Method according to claim 6, characterized in that the compared element is deleted from the simplified document if it is identical to an element already stored.

8. Method according to one of claims 5 to 7, characterized in that the detection of a signature comprises the detection, in the message body, of at least one of the following keywords, situated at the head of a line of characters: mail, email, electronic mail, web, site, blog, telephone, tel, fax, mobile, address, assistant (male and female), leader, department, director, manager, consultant, engineer, quay, road, avenue, cul-de-sac, lane.

9. Method according to one of claims 5 to 8, characterized in that the detection of a signature comprises the detection of at least one image.

10. Method according to claim 9, characterized in that it comprises the deletion, in the simplified document, of any image detected in the email.

11. Method according to one of claims 5 to 8, characterized in that the detection of a signature disregards the presence of any potential image.

12. Method according to one of claims 5 to 11, characterized in that the detection of a legal note comprises the detection of at least one of the following keywords: warning, disclaimer, message, internet, information, error, virus, issuer, sender, integrity, environment, responsibility, confidential, legislation, prohibited.

13. Method according to one of the preceding claims, characterized in that the step of editing the email is followed by a step of detection, in the email, of at least one separation bar between two recalled messages.

14. Method according to claim 13, characterized in that the detected bar is replaced in the simplified document by a thinner bar.

15. Method according to one of the preceding claims, characterized in that it comprises an operation for detecting any hyperlink in the email, and in that the edited document lacks any hyperlink.

16. Method according to one of the preceding claims, characterized in that it comprises an operation for detecting any highlighting in the email, and in that the edited document lacks any highlighting.

17. Method according to one of the preceding claims, characterized in that it comprises the deletion of all recalled unitary messages.

18. Method for printing an electronic document from an email comprising a succession of recalled unitary messages, this method comprising, in addition to the succession of steps of the editing method according to one of the preceding claims, a step of printing the edited simplified document.
